(19) United States
(12) Patent Application Publication
(10) Pub. No.: US 2011/0076532 A1
(43) Pub. Date: Mar. 31, 2011

(54) SECONDARY BATTERY

(75) Inventor: Yun-Kyung HA, Suwon-si (KR)

(73) Assignee: Samsung SDI Co., Ltd, Yongin-si (KR)

(21) Appl. No.: 12/827,034

(22) Filed: Jun. 30, 2010

(30) Foreign Application Priority Data
Sep. 30, 2009 (KR) 10-2009-0093149

(51) Int. Cl. H01M 6/10

(52) U.S. Cl. 429/94

(57) ABSTRACT

A secondary battery includes an electrode assembly formed by winding a first electrode plate, a second electrode plate and a separator. The first and second electrode plates are connected to first and second electrode tabs at one side and another side of the electrode assembly, respectively. The separator is interposed between the first and second electrode plates. A can has one opened portion to accommodate the electrode assembly, and a cap assembly seals the opened portion of the can. In the secondary battery, at least one of the first and second electrode tabs includes a drawing portion protruding upward from the first or second electrode plate and a bonding portion formed by bending one region of the drawing portion to be attached to the cap assembly, and a length of the bonding portion is formed longer than a width of the drawing portion.

### CROSS-REFERENCE TO RELATED APPLICATIONS

This application claims the benefit of Korean Application No. 10-2009-0093149, filed in the Korean Intellectual Property Office on Sep. 30, 2009, the disclosure of which is incorporated herein by reference.

### BACKGROUND

1. Field

Aspects of the present invention relate to a secondary battery, and more particularly, to a secondary battery capable of improving weldability of an electrode tab to a cap assembly and current collection efficiency.

2. Description of the Related Art

Recently, as portable electronic apparatuses are rapidly being made small and light, research on the secondary battery used as a driving power source have been performed. A nickel-cadmium battery, a nickel-hydrogen battery, a nickel-zinc battery, and a lithium secondary battery are generally used as the secondary battery.

The lithium secondary battery is rechargeable, compact, and large in capacity, and thus is widely applied to high-tech electronic devices because of its high operating voltage and high energy density per unit weight. Such a lithium secondary battery may be manufactured by accommodating a jelly-roll type electrode assembly in a can, injecting an electrolyte into the can, and then sealing the top of the can with a cap assembly. The jelly-roll type electrode assembly is formed by respectively coating active materials on a positive electrode collector and a negative electrode collector and then winding the positive electrode collector and the negative electrode collector and a separator interposed between the positive and negative electrode collectors. A cylindrical battery having an electrode assembly accommodated in a cylindrical can or a prismatic battery having an electrode assembly accommodated in a rectangular can is frequently used as the lithium secondary battery.

The electrode assembly is formed by winding the positive electrode plate, the negative electrode plate, and the separator. A positive electrode tab is connected to the positive electrode plate to protrude upward from a top portion of the electrode assembly. A negative electrode tab is connected to the negative electrode plate to protrude upward from a top portion of the electrode assembly. In the electrode assembly, the positive and negative electrode tabs are spaced apart from each other at a predetermined interval so as to be electrically isolated from each other.

The cap assembly includes a cap plate, an insulation plate, a terminal plate, and an electrode terminal. The cap assembly is coupled to a separate insulation case and seals the can while being coupled to the top opening of the can. Holes for positive and negative electrode tabs are formed at the insulation case. The positive and negative electrode tabs are respectively inserted into the holes so as to prevent a short circuit between an upper portion of the electrode assembly inserted into the can and a lower portion of the cap assembly. The insulation case functions to prevent a short circuit that may be caused by the contact of the bent negative and positive electrode tabs with an inner wall of the can.

In the electrode tabs respectively connected to the electrode plates, the positive electrode tab is attached to the cap plate or the can to be electrically connected to the electrode terminal, and the negative electrode tab is attached to the terminal plate to be electrically connected to the electrode terminal. The polarities of the positive and negative electrode tabs may be reversed.

However, an end portion of the electrode tab connected to the electrode plate to protrude upward from the electrode plate is attached to the cap assembly or the can through welding while being slightly bent. Therefore, when the secondary battery receives an impact, a welding defect may occur when a welded portion is broken off due to its weakness, and it is difficult to select a position of the electrode tab.

### SUMMARY

According to aspects of the present invention, a secondary battery is provided, wherein an electrode tab is formed long, so that the area at which the electrode tab is attached to a cap assembly can be broadened, thereby improving weldability of the electrode tab to the cap assembly.

According to an aspect of the present invention, a secondary battery is provided. The secondary battery includes an electrode assembly formed by winding a first electrode plate, a second electrode plate, and a separator, the first electrode plate being connected to a first electrode tab at one side of the electrode assembly, the second electrode plate being connected to a second electrode tab at another side of the electrode assembly, and the separator being interposed between the first and second electrode plates; a can having one opened portion to accommodate the electrode assembly; and a cap assembly to seal the opened portion of the can, wherein at least one of the first and second electrode tabs includes a drawing portion protruding upward from the first or second electrode plate and a bonding portion formed by bending one region of the drawing portion to be attached to the cap assembly, and a length of the bonding portion is formed longer than a width of the drawing portion.

According to another aspect of the present invention, the at least one of the first and second electrode tabs, of which the length of the bonding portion is formed longer than the width of the drawing portion, may be formed of aluminum.

According to another aspect of the present invention, the at least one of the first and second electrode tabs, of which the length of the bonding portion is formed longer than the width of the drawing portion, may be a positive electrode tab.

According to another aspect of the present invention, when the length of the bonding portion of both of the first and second electrode tabs is longer than the width of the drawing portion, end portions of the first and second electrode tabs may be bent in opposite directions to each other.

According to another aspect of the present invention, the first electrode tab may be attached to a cap plate of the cap assembly or to the can, and the second electrode tab may be attached to a terminal plate of the cap assembly.

According to another aspect of the present invention, the drawing portion of the at least one of the first and second electrode tabs may be bent twice to form a “T” shape.

According to another aspect of the present invention, the first and second electrode tabs may be welded to the cap assembly.

According to another aspect of the present invention, the welding may be an ultrasonic or resistance welding.

According to another aspect of the present invention, the number of welding points at the bonding portion may be from 3 to 10.

According to another aspect of the present invention, the welding points at the bonding portion may be sequentially formed in the length direction of the bonding portion.

According to another aspect of the present invention, a welding portion at the bonding portion may be formed longer in the length direction of the bonding portion than in the width direction of the bonding portion.

According to another aspect of the present invention, the secondary battery may further include an insulation case positioned between the electrode assembly and the cap assembly.

As described above, according to aspects of the present invention, an electrode tab is formed long, so that the area at which the electrode tab is attached to a cap assembly can be broadened. Accordingly, it is possible to improve weldability of the electrode tab to the cap assembly and current collection efficiency. Further, the position of the electrode tab can be easily selected by considering alignment when winding an electrode assembly.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a secondary battery according to an embodiment of the present invention;

FIG. 2 is an assembled sectional view of the secondary battery of FIG. 1;

FIG. 3 is a perspective view of an electrode tab according to an embodiment of the present invention;

FIG. 4A is a perspective view illustrating a welding state of the electrode tab according to an embodiment of the present invention;

FIG. 4B is a perspective view illustrating another welding state of the electrode tab according to an embodiment of the present invention; and

FIG. 5 is a perspective view of an electrode tab according to another embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween.

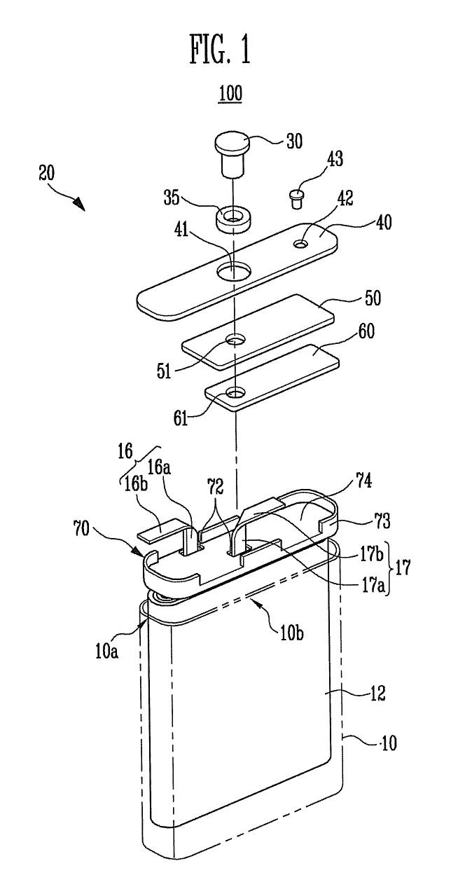

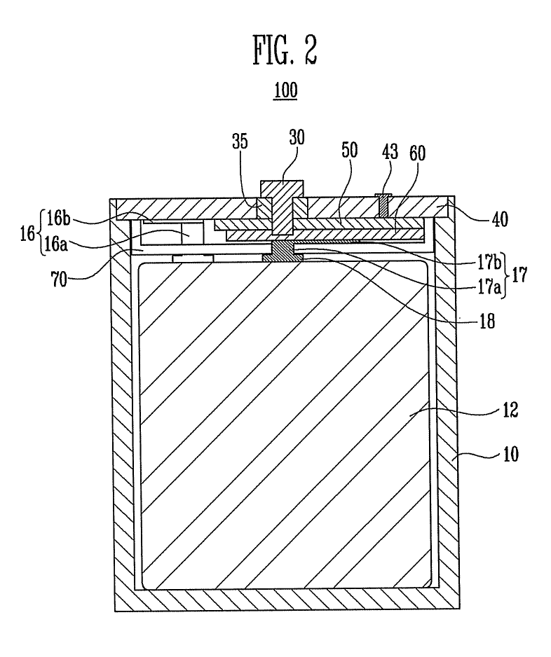

FIG. 1 is an exploded perspective view of a secondary battery 100 according to an embodiment of the present invention. FIG. 2 is an assembled sectional view of the secondary battery 100 of FIG. 1. Referring to FIGS. 1 and 2, the secondary battery 100 includes an electrode assembly 12, a can 10, a cap assembly 20, and an insulation case 70 positioned between the electrode assembly 12 and the cap assembly 20.

The can 10 accommodates the electrode assembly 12 through an opened portion thereof. The horizontal section of the can 10 is formed in a rectangular shape with rounded corners and includes a pair of short side portions 10a and a pair of long side portions 10b. The horizontal section of the can 10 is not limited thereto. Although not shown in the figures, according to other aspects of the present invention, the horizontal section of the can 10 may be formed in a rectangular or elliptical shape. The can 10 may be formed of a metallic material that is light and flexible, such as aluminum or aluminum alloy. The can 10 may be easily manufactured using a deep drawing method.

The electrode assembly 12 inserted into the can 10 is formed by winding a first electrode plate (not shown), a second electrode plate (not shown), and a separator (not shown) interposed between the first and second electrode plates. A first electrode tab 16 is connected to the first electrode plate to protrude upward from a top portion of the electrode assembly 12, and a second electrode tab 17 is connected to the second electrode plate to protrude upward from a top portion of the electrode assembly 12. For convenience of illustration, the first and second electrode tabs 16 and 17 are hereinafter referred to as positive and negative electrode tabs, respectively. However, according to other aspects of the present invention, the second electrode tab 17 may be a positive electrode tab and the first electrode tab 16 may be a negative electrode tab.

In the electrode assembly 12, the positive and negative electrode tabs 16 and 17 are spaced apart from each other at a predetermined interval so as to be electrically isolated from each other. A lamination tape 18 is wound at a portion of each of the positive and negative electrode tabs 16 and 17, drawn out from the electrode assembly 12. The lamination tape 18 blocks heat generated from the positive or negative electrode tab 16 or 17 and prevents the electrode assembly 12 from being compressed by an edge of the positive or negative electrode tab 16 or 17.

The positive and negative electrode tabs 16 and 17 are electrically connected to the positive and negative electrode plates of the electrode assembly 12, respectively. The positive and negative electrode tabs 16 and 17 are drawn out in the opened direction of the can 10. To this end, the positive and negative electrode tabs 16 and 17 are electrically connected to the cap plate 40 or can 10 and the terminal plate 60 by passing through lid through-holes 72 of the insulation case 70 fixed to the top of the electrode assembly 12 in the can 10, respectively.

The positive and negative electrode tabs 16 and 17 have drawing portions 16a and 17a and bonding portions 16b and 17b, respectively. The drawing portions 16a and 17a are respectively protruded upward from the positive and negative electrode plates, and the bonding portions 16b and 17b are respectively formed by bending one region of each of the drawing portions 16a and 17a to be attached to the cap assembly 20. The length of each of the bonding portions 16b and 17b is formed to be longer than the width of each of the drawing portions 16a and 17a. End portions of the positive and negative electrode tabs 16 and 17 are bent in directions opposite to each other. Accordingly, a welding portion formed at each of the electrode tabs 16 and 17 is formed broader than that formed at each of the conventional electrode tabs, so that welding defects of the electrode tabs 16 and 17 can be reduced. Further, the positions of the electrode tabs 16 and 17 can be easily selected by considering alignment when winding the electrode assembly 12.

As described above, the drawing portions 16a and 17a and the bonding portions 16b and 17b are formed at both of the positive and negative electrode tabs 16 and 17, respectively. However, the drawing portion 16a and the bonding portion 16b may be formed only at the positive electrode tab 16 formed of aluminum. Since aluminum is weak to welding, it is difficult to control its weld strength. For example, aluminum is broken if its weld strength is intensified, and its weldability is lowered if its weld strength is weakened. Accordingly, the welding portion is broadened, so that the attachment of the positive electrode tab 16 to the cap plate 40 or can 10 can be maintained by the welding at one region of the welding portion even though the welding at another region of the welding portion has failed.

The positive electrode plate and the negative electrode plate are manufactured by dry-coating an aluminum metal foil and a copper metal foil with respective slurries. The slurries include active materials of the positive and negative electrode plates and a fixing agent to attach the respective active materials to the metal foils. In the case of a lithium secondary battery, an oxide containing lithium may be used as a positive electrode active material, and any one of hard carbon, soft carbon, graphite and a carbon material may be used as a negative electrode active material. However, aspects of the present invention are not limited to the lithium secondary battery. For example, according to other aspects of the present invention, the secondary battery 100 may be a nickel-cadmium battery, nickel-hydrogen battery, nickel-zinc battery, or other type of secondary battery.

The cap assembly 20 includes a cap plate 40, an electrode terminal 30, an insulation plate 50, a terminal plate 60 and a gasket 35. When the cap assembly 20 is coupled to the can 10, the cap plate 40 allows the opened portion of the can 10 to be sealed tightly, thereby forming one surface of the can 10. To this end, the cap plate 40 may be coupled to the opened portion of the can using a method such as welding.

Hereinafter, the components of the cap assembly 20 will be described in detail. The cap plate 40 is electrically connected to either the positive electrode tab 16 or the negative electrode tab 17 protruded by respectively passing through the lid through-holes 72 of the insulation case 70. A first terminal hole 41 for coupling the gasket 35 to the cap plate 40 therethrough and an electrolyte injection hole 42 for injecting an electrolyte are formed at the cap plate 40. The electrolyte injection hole 42 is formed at the cap plate 40 and used as a passage through which the electrolyte is injected into the can 10. After the electrolyte is injected into the can 10, the electrolyte injection hole 42 is tightly sealed with a stopper 43.

The gasket 35 provides insulation between the electrode terminal 30 and the cap plate 40. A terminal hole to couple the electrode terminal 30 to the gasket 35 therethrough is formed at the gasket 35, and the electrode terminal 30 is coupled to the gasket 35 by passing through the terminal hole.

The terminal plate 60 is electrically connected to the electrode terminal 30 through a third terminal hole 61. The terminal plate 60 is electrically connected to whichever of the positive and negative electrode tabs 16 and 17 is not connected to the cap plate 40. For example, when the cap plate 40 is electrically connected to the positive electrode tab 16, the terminal plate 60 is connected to the negative electrode tab 17. Accordingly, the terminal plate 60 can provide electrical connection of the electrode terminal 30 and the negative electrode tab 17.

The insulation case 70 is positioned between the electrode assembly 12 and the cap assembly 20 so that they are electrically isolated from each other. The insulation case 70 is positioned such that it is inserted into the top portion of the can 10. Corners of the insulation case 70 are formed in a rounded rectangular shape identical to the horizontal sectional shape of the can 10 so that the insulation case 70 can be forcibly fitted into the can 10.

The insulation case 70 is generally manufactured using a light plastic resin with excellent electric insulation, although other materials with similar properties may also be employed. Therefore, when the insulation case 70 is inserted into the can 10, the deformation of the insulation case 70 is not caused by the electrolyte, and it is easy to provide insulation between the electrode assembly 12 and the cap assembly 20. However, when a light plastic resin is used as the insulation case 70, it may be difficult to couple the insulation case 70 to the can 10 due to its weak elasticity. To solve such a problem, the insulation case 70 includes a base portion 74 and a support portion 73. Accordingly, the insulation case 70 can be stably coupled to the can 10. An electrolyte injection hole (not shown) and lid through holes 72 are formed at the base portion 74.

FIG. 3 is a perspective view of an electrode tab according to an embodiment of the present invention. Referring to FIG. 3, the positive electrode tab 16 is provided with a drawing portion 16a and a bonding portion 16b formed by bending one region of the drawing portion 16a once. The positive electrode tab 16 may be formed so that the drawing portion 16a is bent at 90 degrees to the horizontal direction. Accordingly, a wide and flat surface of the bonding portion 16b of the positive electrode tab 16 can be attached to the cap plate 40 or the can 10.

If the width of the drawing portion 16a of the positive electrode tab 16 is “A” and the length of the bonding portion 16b formed by bending the drawing portion 16a of the positive electrode tab 16 is “B”, “B” is formed longer than “A”. Thus, the area of the bonding portion 16b attached to the cap plate 40 or the can 10 is increased, so that the weldable region of the positive electrode tab 16 can be broadened.

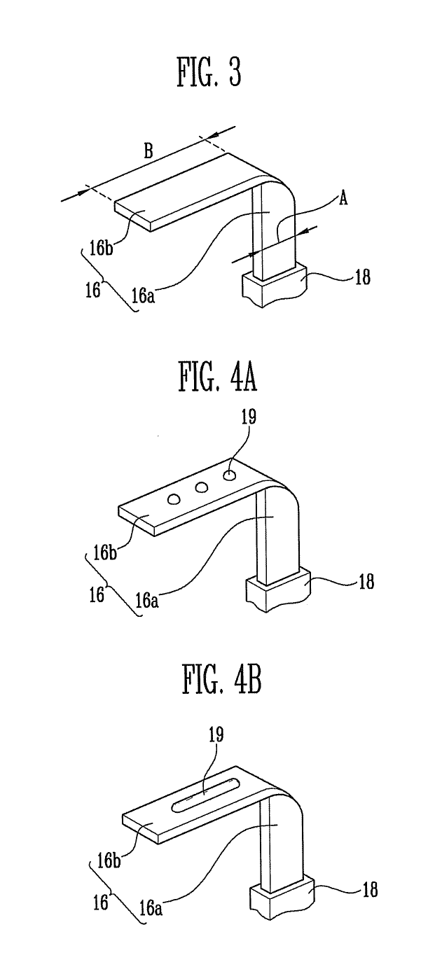

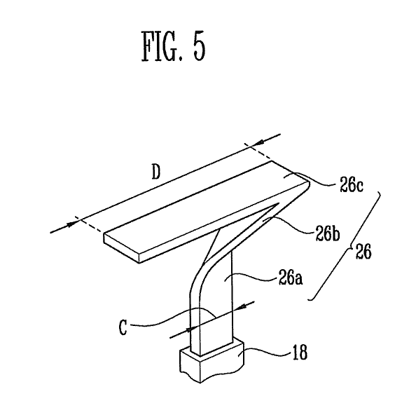

FIG. 4A is a perspective view illustrating a welding state of the electrode tab according to an embodiment of the present invention. FIG. 4B is a perspective view illustrating another welding state of the electrode tab according to an embodiment of the present invention.

The bonding portion 16b is attached to the can 10 or the cap plate 40 by welding. The welding may be an ultrasonic or resistance welding. Referring to FIG. 4A, three welding points 19 are formed at the bonding portion 16b. The welding points 19 may be sequentially formed in the length direction of the bonding portion 16b. However, aspects of the present invention are not limited thereto. The number of welding points 19 may be from 3 to 10. If the number of welding points 19 is below 3, the electrode tab 16 may be separated from the can 10 or the cap plate 40 due to its weak welding portion. If the number of welding points 19 is over 10, the effect may not be superior to that when the number of welding points is 10 or less, and productivity may be lowered. Referring to FIG. 4B, the welding point 19 formed at the bonding portion 16b may be formed long in the length direction of the bonding portion 16b.

The ultrasonic welding is performed while removing foreign matters (a pollutant, an oxide and the like) formed between pressurized objects to be welded with high-frequency vibration energy generated by ultrasonic waves of 20 kHz and narrowing the gap between the objects to be welded by an interatomic distance. Since heat is not applied in the ultrasonic welding, the ultrasonic welding is classified as a cold welding. Accordingly, it is possible to prevent thermal damage caused by welding.

In the resistance welding, a large amount of current is transmitted through a welding base metal so that heat is generated by contact resistance of its welding portion. Then, the welding base metal is heated with the generated heat to be in a melted state, and mechanical pressure is applied to the welding base metal. The resistance welding is classified into a butt welding, a point welding, and the like. The butt welding is used when welding the ends of metal rods, pipes, or the like. If current is transmitted while their ends are connected to each other, a bonding portion is heated red hot. The butt welding is performed by applying pressure to the bonding portion.

In the point welding, welding base metals are stacked, and rod-shaped electrodes formed of a copper alloy are connected to upper and lower sides of the stacked welding base metals. Then, a strong current is transmitted into the welding base metals through the electrodes under a pressure atmosphere. When the temperature of contact portions between the electrodes and the welding base metal is increased, the point welding is performed by re-applying pressure to the contact portions.

FIG. 5 is a perspective view of an electrode tab according to another embodiment of the present invention. Referring to FIG. 5, the positive electrode tab 26 according to the embodiment of the present invention may be formed in a “T” shape by bending a drawing portion 26a twice. The positive electrode tab 26 may be formed by first bending one region 26b of the drawing portion 26a at 90 degrees to the horizontal direction and then bending another region 26c of the drawing portion 26a in the opposite direction to that of the first bent region 26b of the drawing portion 26a so as to partially overlap with the first bent region 26b. Accordingly, the shape of the positive electrode tab 26 formed by bending the drawing portion 26a twice is a “T” shape, and a wide and flat surface of the positive electrode tab 26 can be attached to the cap plate 40 or the can 10.

If the width of the drawing portion 26a of the positive electrode tab 26 is “C” and the length of the bonding portion 26c formed by bending the drawing portion 26a twice is “D”, “D” may be formed longer than “C”. Accordingly, the area of the bonding portion 26c attached to the cap plate 40 or the can 10 is increased, so that the weldable region of the positive electrode tab 26 can be broadened.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A secondary battery comprising:
an electrode assembly formed by winding a first electrode plate, a second electrode plate, and a separator, the first electrode plate being connected to a first electrode tab at one side of the electrode assembly, the second electrode plate being connected to a second electrode tab at another side of the electrode assembly, and the separator being interposed between the first and second electrode plates;
a can having one opened portion to accommodate the electrode assembly; and
a cap assembly to seal the opened portion of the can;
wherein at least one of the first and second electrode tabs comprises a drawing portion protruding upward from the first or second electrode plate and a bonding portion formed by bending one region of the drawing portion to be attached to the cap assembly, and a length of the bonding portion is formed longer than a width of the drawing portion.

2. The secondary battery according to claim 1, wherein the at least one of the first and second electrode tabs, of which the length of the bonding portion is formed longer than the width of the drawing portion, is formed of aluminum.

3. The secondary battery according to claim 1, wherein the at least one of the first and second electrode tabs, of which the length of the bonding portion is formed longer than the width of the drawing portion, is a positive electrode tab.

4. The secondary battery according to claim 1, wherein, when the length of the bonding portion of both of the first and second electrode tabs is longer than the width of the drawing portion, end portions of the first and second electrode tabs are bent in opposite directions to each other.

5. The secondary battery according to claim 1, wherein:
the first electrode tab is attached to a cap plate of the cap assembly or to the can; and
the second electrode tab is attached to a terminal plate of the cap assembly.

6. The secondary battery according to claim 1, wherein the drawing portion of the at least one of the first and second electrode tabs is bent twice to form a “T” shape.

7. The secondary battery according to claim 1, wherein the first and second electrode tabs are welded to the cap assembly.

8. The secondary battery according to claim 7, wherein the welding is an ultrasonic or resistance welding.

9. The secondary battery according to claim 7, wherein the number of welding points at the bonding portion is from 3 to 10.

10. The secondary battery according to claim 7, wherein the welding points at the bonding portion are sequentially formed in the length direction of the bonding portion.

11. The secondary battery according to claim 7, wherein a welding portion at the bonding portion is formed longer in a length direction of the bonding portion than in a width direction of the bonding portion.

12. The secondary battery according to claim 1, further comprising an insulation case positioned between the electrode assembly and the cap assembly.

13. The secondary battery according to claim 1, wherein the cap assembly further comprises:
a cap plate electrically connected to one of the first electrode tab and the second electrode tab and having a first terminal through-hole;
a terminal plate attached to the other of the first electrode tab and the second electrode tab, and having a third terminal through-hole aligned with the first terminal through-hole;
an insulation plate arranged between the cap plate and the electrode terminal and having a second terminal through-hole aligned with the first terminal through-hole and the third terminal through-hole;
an electrode terminal inserted into the first terminal through-hole, the second terminal through-hole, and the third terminal through-hole and electrically connected to the electrode terminal; and
a gasket inserted into the first terminal through-hole to insulate the electrode terminal from the cap plate.

14. The secondary battery according to claim 1, wherein both the first electrode tab and the second electrode tab include the drawing portion protruding upward from the first or second electrode plate and the bonding portion formed by bending one region of the drawing portion to be attached to the cap assembly.

15. The secondary battery according to claim 1, wherein the bonding portion is bent ninety degrees with respect to the drawing portion.

16. The secondary battery according to claim 1, further comprising:
an insulation case arranged between the cap assembly and the electrode assembly to isolate the cap assembly and the electrode assembly, the insulation case including:
a base,
a support portion protruding from the base away from the electrode assembly, and
a first through-hole to accommodate the first electrode tab and a second through-hole to accommodate the second electrode tab.

17. The secondary battery according to claim 1, wherein the insulation case is formed of a light plastic resin.

18. An electrode assembly for a secondary battery, the electrode assembly comprising:
a first electrode plate;
a second electrode plate;
a separator arranged between the first electrode plate;
a first electrode tab connected to the first electrode plate and protruding from a top of the electrode assembly;
a second electrode tab connected to the second electrode plate and protruding from a top of the electrode assembly;
wherein a portion of at least one of the first electrode tab and the second electrode tab protruding from the electrode assembly is bent with respect to the remainder of the at least one of the first electrode tab and the second electrode tab, and
wherein the first electrode plate, second electrode plate, and separator are wound around each other.
